(19) United States
(12) Patent Application Publication
(10) Pub. No.: US 2024/0302914 A1
(43) Pub. Date: Sep. 12, 2024

(54) METHOD FOR CONTROLLING ELECTRONIC DEVICE BY IDENTIFYING SHEAR STRESS PATTERN IN REGION WHERE TWO INPUTTERS CONTACT EACH OTHER, AND THE ELECTRONIC DEVICE

(71) Applicant: SAMSUNG ELECTRONICS CO., LTD., Suwon-si (KR)

(72) Inventors: Kostyantyn SLYUSARENKO, Kyiv (UA); Denys ZAKUTAILO, Kyiv (UA)

(73) Assignee: SAMSUNG ELECTRONICS CO., LTD., Suwon-si (KR)

(21) Appl. No.: 18/218,334

(22) Filed: Jul. 5, 2023

Related U.S. Application Data
(63) Continuation of application No. PCT/KR2023/003041, filed on Mar. 6, 2023.

(30) Foreign Application Priority Data
Mar. 10, 2022 (KR) 10-2022-0030319

(51) Int. Cl. G06F 3/041; G06F 3/044

(52) U.S. Cl. CPC G06F 3/0414; G06F 3/0447; G06F 2203/04102; G06F 2203/04104; G06F 2203/04105

(57) ABSTRACT

Provided is a method of obtaining a control signal by identifying a shear stress pattern in a region where two inputters contact each other. The method includes obtaining, through a sensor, an input according to an interaction between a first inputter and a second inputter, identifying a shear stress pattern in a region in which the first inputter and the second inputter contact each other, and identifying, based on the identified shear stress pattern, a control signal corresponding to the input.

### CROSS-REFERENCE TO RELATED APPLICATIONS

This application is a by-pass continuation application of International Application No. PCT/KR2023/003041, filed on Mar. 6, 2023, which is based on and claims priority to Korean Patent Application No. 10-2022-0030319, filed on Mar. 10, 2022, in the Korean Intellectual Property Office, the disclosures of which are incorporated by reference herein in their entireties.

### TECHNICAL FIELD

The disclosure relates to a method for controlling an electronic device by identifying a shear stress pattern in a region where two input units are in contact with each other, and the electronic device.

### BACKGROUND ART

Human-computer interactions require means for inputting data to a system. Many systems, like virtual reality (VR), augmented reality (AR), or mixed reality (MR) systems, do not have special input terminals and require a method of delivering information without additional tools and sensors.

Recently, with the development of image processing technology and image recognition technology using computers, various applications using these technologies have been developed. Among these various applications, a gesture recognition technology is one method for information transfer means that has been constantly developed. Gesture recognition technology is a technology in which a computer autonomously analyzes and recognizes human behaviors, and may include touch gesture technology and spatial gesture technology. In detail, touch gesture technology is a technology capable of selecting an item by using an input device such as a touch screen, and use of the touch gesture technology is increasing with the spread of smart phones. Spatial gesture technology is a technology of analyzing how the motion of a tracking target changes over time by using an input device such as a camera, and interpreting the change in an abstract meaning. In such gesture recognition technology, more quickly and accurately recognizing a user's intention may be a key factor.

Nowadays, a touch screen is used as a basic input mechanism for a wide range of interactive devices such as smartphones, tablet PCs, and entertainment systems. In human interface device (HID) mobile devices, a touch signal is input to a smartphone, a tablet PC, etc. by using a user's finger or by using a stylus pen, which is a type of digitizer pen capable of writing or drawing. An input through a stylus pen may enable more detailed input compared to an input using a finger, and may support functions such as detailed drawing and writing.

Information input on current AR, VR, or MR systems is based on voice recognition technology, a technology using a separate auxiliary device, and gesture recognition technology through an image. When the voice recognition technology is used as an input means, it may be vulnerable to noise caused by an external environment, and may infringe user's privacy. When a separate auxiliary device is used as an input means, an additional device is needed, and a delay may occur during an exchange of information between devices. When gesture recognition through an image is used as an input means, a recognition rate for a complex gesture may be low, and only a relatively simple control signal may be applied.

Thus, there is a need for an effective input unit that is conveniently usable in AR, VR, or MR systems, is security-enhanced and robust, and has fast response.

### DESCRIPTION OF EMBODIMENTS

### Technical Problem

Provided are an electronic device and method capable of obtaining inputs of various control signals by identifying a control signal corresponding to an input, based on a shear stress pattern in a region where two input units are in contact with each other.

Provided are an electronic device and method capable of obtaining an input of a control signal without additional separate auxiliary means or increasing the accuracy of identification of a control signal input through auxiliary means, by identifying a shear stress pattern in a contact region where two input units contact each other, based on an image of the contact region obtained through a camera.

### Solution to Problem

According to an aspect of the disclosure, a method of obtaining a control signal by identifying a shear stress pattern in a region where two inputters contact each other includes: obtaining, through a sensor, an input according to an interaction between a first inputter and a second inputter; identifying a shear stress pattern in a region in which the first inputter and the second inputter contact each other; and identifying, based on the identified shear stress pattern, a control signal corresponding to the input.

The sensor may include at least one of a camera, an infrared camera, a depth sensor, a lidar, or an ultra-wideband (UWB) radar.

The sensor may further include a stress sensor.

The first inputter may include a display, and the stress sensor may be disposed along an edge of the display, on a surface of the display, or in a grid pattern on a portion of the display.

The first inputter may include an elastic surface having elasticity and flexibility, and the elastic surface may include a region in which the first inputter and the second inputter contact each other.

The shear stress pattern may be identified based on a degree of deformation of the elastic surface in the region in which the first inputter and the second inputter contact each other.

The degree of deformation of the elastic surface may include at least one of a degree of shape deformation of the elastic surface or a degree of color deformation of the elastic surface.

The shear stress pattern may be identified based on at least one of a location where the first inputter and the second inputter contact each other, a strength of a shear stress, a direction of the shear stress, or a magnitude of a normal force.

The second inputter may include at least one of a user's finger or a stylus pen.

The second inputter may include an elastic surface having elasticity and flexibility, and the elastic surface may include the region in which the first inputter and the second inputter contact each other.

According to an aspect of the disclosure, an electronic device for obtaining a control signal by identifying a shear stress pattern in a region where two inputters contact each other includes: a sensor configured to obtain an input according to an interaction between a first inputter and a second inputter; a memory configured to store a program including at least one instruction; and at least one processor configured to execute the at least one instruction stored in the memory to: obtain, through the sensor, the input according to the interaction between the first inputter and the second inputter; identify a shear stress pattern in a region in which the first inputter and the second inputter contact each other; and identify, based on the identified shear stress pattern, a control signal corresponding to the input.

The sensor may include at least one of a camera, an infrared camera, a depth sensor, a lidar, or an ultra-wideband (UWB) radar.

The sensor may further include a stress sensor.

The first inputter may be included in the electronic device and may include a display, and the stress sensor may be disposed along an edge of the display, on a surface of the display, or in a grid pattern on a portion of the display.

The first inputter may include an elastic surface having elasticity and flexibility, and the elastic surface may include the region where the first inputter and the second inputter contact each other.

The at least one processor may be further configured to execute the at least one instruction to identify the shear stress pattern, based on a degree of deformation of the elastic surface in the region in which the first inputter and the second inputter contact each other.

The degree of deformation of the elastic surface may include at least one of a degree of shape deformation of the elastic surface or a degree of color deformation of the elastic surface.

The at least one processor may be further configured to execute the at least one instruction to identify the shear stress pattern, based on at least one of a location where the first inputter and the second inputter contact each other, a strength of a shear stress, a direction of the shear stress, or a magnitude of a normal force.

The second inputter may include at least one of a user's finger or a stylus pen.

According to an aspect of the disclosure, a non-transitory computer-readable recording medium having recorded thereon a computer program to perform a method, including: obtaining, through a sensor, an input according to an interaction between a first inputter and a second inputter; identifying a shear stress pattern in a region in which the first inputter and the second inputter contact each other; and identifying, based on the identified shear stress pattern, a control signal corresponding to the input.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a flowchart of a method of obtaining a control signal by identifying a shear stress pattern in a region where two input units contact each other, according to an embodiment of the disclosure;

FIG. 2 is a view illustrating a shear stress pattern, according to an embodiment of the disclosure;

FIG. 3 is a view illustrating an operation of identifying a shear stress pattern by using a camera, according to an embodiment of the disclosure;

FIG. 4 is a view illustrating a shear stress, according to an embodiment of the disclosure;

FIG. 5 is a view illustrating a shear stress and a deformation stress, according to an embodiment of the disclosure;

FIG. 6 is a view illustrating an operation of identifying a shear stress pattern by using a stress sensor, according to an embodiment of the disclosure;

FIG. 7 is a block diagram of an electronic device, according to an embodiment of the disclosure; and

FIG. 8 is a view illustrating a stress sensor, according to an embodiment of the disclosure.

### MODE OF DISCLOSURE

Throughout the disclosure, the expression “at least one of a, b or c” indicates only a, only b, only c, both a and b, both a and c, both b and c, all of a, b, and c, or variations thereof.

Embodiments of the disclosure will now be described more fully with reference to the accompanying drawings such that one of ordinary skill in the art to which the disclosure pertains may easily execute the disclosure. The disclosure may, however, be embodied in many different forms and should not be construed as being limited to the embodiments set forth herein. In the drawings, parts irrelevant to the description are omitted for the simplicity of explanation, and like numbers refer to like elements throughout.

Although general terms widely used at present were selected for describing embodiments of the disclosure in consideration of the functions thereof, these general terms may vary according to intentions of one of ordinary skill in the art, case precedents, the advent of new technologies, or the like. Terms arbitrarily selected by the applicant of the disclosure may also be used in a specific case. In this case, their meanings need to be given in the detailed description of an embodiment of the disclosure. Hence, the terms must be defined based on their meanings and the contents of the entire specification, not by simply stating the terms.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

Throughout the disclosure, the terms “comprises” and/or “comprising” or “includes” and/or “including” when used in this disclosure, specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

Throughout the specification, when an element is referred to as being “connected” or “coupled” to another element, it can be directly connected or coupled to the other element, or can be electrically connected or coupled to the other element with intervening elements interposed therebetween. In addition, the terms “comprises” and/or “comprising” or “includes” and/or “including” when used in this disclosure, specify the presence of stated elements, but do not preclude the presence or addition of one or more other elements.

The expression “configured to (or set to)” used herein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or component parts. For example, the phrase “a processor configured (or set) to perform A, B, and C” may refer to a dedicated processor (such as an embedded processor) for performing a corresponding operation, or a generic-purpose processor (such as a central processing unit (CPU) or an application processor (AP)) that can perform a corresponding operation by executing one or more software programs stored in a memory.

Functions related to AI according to the disclosure are operated through a processor and a memory. The processor may include one or a plurality of processors. The one or plurality of processors may be a general-purpose processor such as a CPU, an AP, or a Digital Signal Processor (DSP), a graphics-only processor such as a GPU or a Vision Processing Unit (VPU), or an AI-only processor such as an NPU. The one or plurality of processors control to process input data, according to a predefined operation rule or AI model stored in the memory. Alternatively, when the one or plurality of processors are AI-only processors, the AI-only processors may be designed in a hardware structure specialized for processing a specific AI model.

The predefined operation rule or AI model is created through learning. Here, the predefined operation rule or AI model being made through learning means that a basic AI model is learned using a plurality of learning data by a learning algorithm, so that a predefined operation rule or AI model set to perform desired characteristics (or a purpose) is created. Such learning may be performed in a device itself on which AI according to the disclosure is performed, or may be performed through a separate server and/or system. Examples of the learning algorithm include, but are not limited to, supervised learning, unsupervised learning, semi-supervised learning, or reinforcement learning.

The AI model may be composed of a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized by the learning result of the AI model. For example, a plurality of weight values may be updated so that a loss value or a cost value obtained from the AI model is reduced or minimized during a learning process. The artificial neural network may include a deep neural network (DNN), for example, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), or a Deep Q-Networks, but embodiments of the disclosure are not limited thereto.

In the disclosure, ‘stress’ refers to a resistance force generated inside an object when an external force is applied to the object. ‘Shear stress’ is a stress acting parallel to the surface of an object, and refers to a resistance force trying to restore the surface of an object to its original state, when a force is applied to the surface of the object from the outside in a direction parallel to the surface of the object. When a shear stress is applied to an object, deformation may occur on the surface of the object and in a region of a certain depth from the surface.

The disclosure will now be described more fully with reference to the accompanying drawings.

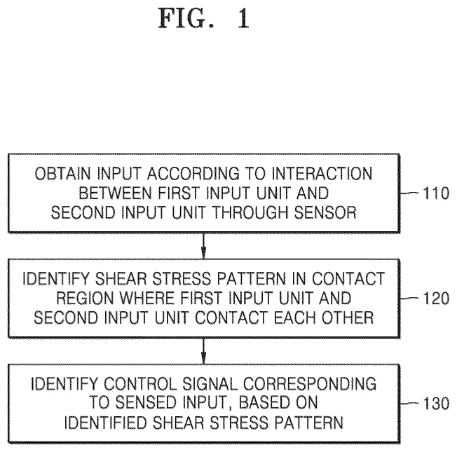

FIG. 1 is a flowchart of a method of obtaining a control signal by identifying a shear stress pattern in a region where two input units (e.g., inputters) contact each other, according to an embodiment of the disclosure.

According to an embodiment of the disclosure, a user may input information to an electronic device. A system including an electronic device may include at least two input units including a first input unit (e.g., first inputter) and a second input unit (e.g., second inputter).

The first input unit may be included in the electronic device or may be included in an object different from the electronic device. For example, when the first input unit is included in the electronic device, the first input unit may be a display panel made of a material having elasticity and flexibility. For example, when the first input unit is included in an object different from the electronic device, the first input unit may be another object or another electronic device, such as a part of a user's body (e.g., a user's finger) or a stylus pen. The second input unit may also be included in the electronic device or may be included in an object different from the electronic device.

In an embodiment of the disclosure, the first input unit and the second input unit may be included in objects different from the electronic device, respectively. For example, the first input unit may be a part of the user's body such as the back of the user's hand, and the second input unit may be another object or another electronic device, such as a stylus pen. In an embodiment of the disclosure, the first input unit and the second input unit may be included in a single object different from the electronic device. For example, the first input unit may correspond to the back of the user's hand and the second input unit may correspond to the user's finger, or the first input unit and the second input unit may correspond to different fingers of the user, respectively.

In an embodiment of the disclosure, the first input unit may include an elastic surface made of a material having elasticity and flexibility. The second input unit may include a user's finger, a stylus pen, or the like. In an embodiment of the disclosure, the second input unit may also include an elastic surface having elasticity and flexibility, and, in this case, the elastic surface included in the second input unit may include a region in which the first input unit and the second input unit contact each other. For example, the first input and the second input unit may provide an interaction, e.g., a contact, on the elastic surfaces respectively included therein.

Referring to FIG. 1, in operation 110, the electronic device obtains an input according to an interaction between the first input unit and the second input unit through a sensor.

In an embodiment of the disclosure, the interaction between the first input unit and the second input unit may be a contact between the first input unit and the second input unit within the contact region. For example, a portion of the surface of the first input unit may be in contact with a portion of the surface of the second input unit within the contact region. The contact of the first input unit and the second input unit may generate a shear stress in the contact region, and may be an interaction between the first input unit and the second input unit and thus serve as a basis of an input to the electronic device. An input according to the interaction between the first input unit and the second input unit may be obtained from the electronic device through the sensor.

A sensor including a camera may be used in an operation, performed by the electronic device, of obtaining the input according to the interaction between the first input unit and the second input unit. For example, the sensor may include at least one of a camera, an infrared camera, a depth sensor, a lidar, or an ultra-wideband (UWB) radar.

In an embodiment of the disclosure, the sensor may further include a stress sensor that measures a degree of deformation of the surface of the first input unit or the second input unit in the contact region or a shear stress applied to a contact point where the first input unit and the second input unit contact each other. For example, the stress sensor may be embedded in the surface of the first input unit or the second input unit. The stress sensor embedded in the surface of the first input unit may measure a degree of deformation of the surface of the first input unit or a shear stress applied to a contact point on the surface of the first input unit. The stress sensor embedded in the surface of the second input unit may measure a degree of deformation of the surface of the second input unit or a shear stress applied to a contact point on the surface of the second input unit. In an embodiment of the disclosure, when the first input unit includes a display, stress sensors may be arranged along an edge of the display, spaced apart from each other over the surface of the display, or arranged in a grid pattern along a face of the display.

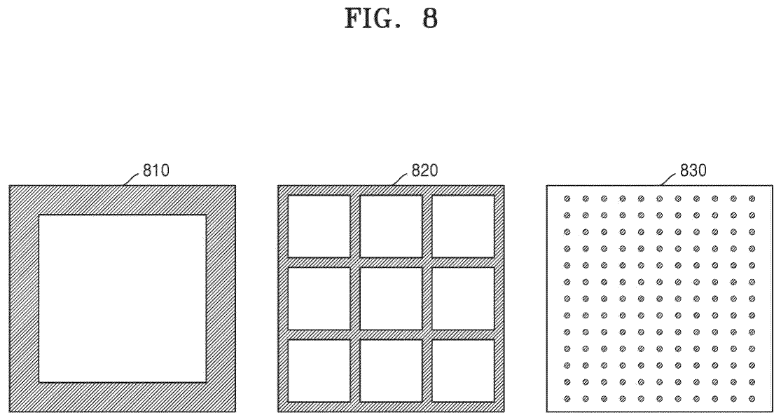

In an embodiment of the disclosure, the stress sensor measuring the degree of deformation of the surface of the first input unit may measure a distance difference between a plurality of feature points on the surface of the first input unit and may obtain the degree of deformation of the surface from the measured distance difference. For example, the stress sensor may obtain the degree of deformation of the surface of the first input unit by comparing pre-stored arrangement information of the plurality of feature points on the surface of the first input unit in a non-contact initial state with arrangement information of the plurality of feature points in a state in which contact has been made. An operation, performed by the stress sensor according to an embodiment of the disclosure, of sensing a shear stress serving as a basis of an input in the contact region where the first input unit and the second input unit contact each other will be described in more detail with reference to FIG. 8, which will be described later.

In operation 120, the electronic device identifies a shear stress pattern in the contact region where the first input unit and the second input unit contact each other. The electronic device may identify the shear stress pattern in the contact region, based on the obtained input according to the interaction between the first input unit and the second input unit.

In an embodiment of the disclosure, the user may touch or press a portion of the surface of the first input unit using by the second input unit. In this case, a shear stress may be applied to the contact region of the first input unit and the second input unit. The user may cause a shape change or a color change on the surface of at least one of the first input unit or the second input unit by bringing the first input unit and the second input unit into contact. The electronic device may identify the shear stress pattern from shape deformation information or color deformation information on the surface of at least one of the first input unit or the second input unit in the contact region where the first input unit and the second input unit contact each other.

In an embodiment of the disclosure, the shear stress pattern may be identified based on at least one of a position of the contact point where the first input unit and the second input unit contact each other, the strength of the shear stress, the direction of the shear stress, or the magnitude of a normal force. For example, when the shear stress has different directions even though the position of the contact point where the first input unit and the second input unit contact each other and the strength of the shear stress do not change, it may be considered that different shear stress patterns are generated. Likewise, when the shear stress has different strengths even though the position of the contact point where the first input unit and the second input unit contact each other and the direction of the shear stress do not change, it's may be considered that different shear stress patterns are generated.

For example, the first input unit may be a display screen included in the electronic device, and the second input unit may be a stylus pen. In this case, various shear stress patterns may be identified according to, for example, which location on the display screen (first input unit) the user touches using the stylus pen (second input unit), how strongly the user presses the display screen (first input unit) with the stylus pen (second input unit), or in which direction the stylus pen (second input unit) moves while pressing the display screen (first input unit). How strongly the user presses the display screen (first input unit) by using the stylus pen (second input unit) may be identified based on the degree of deformation of the surface of the display screen (first input unit).

For example, the first input unit may be a display screen included in the electronic device, and the second input unit may be the user's finger. In this case, various shear stress patterns may be identified according to, for example, which location on the display screen (first input unit) the user touches using the user's finger (second input unit), how strongly the user presses the display screen (first input unit) with the user's finger (second input unit), or in which direction the user's finger (second input unit) moves while pressing the display screen (first input unit). How strongly the user presses the display screen (first input unit) with the finger (second input unit) or in which direction the user's finger moves while pressing the display screen (first input unit) may be identified based on the degree of shape change and the degree of color change on the surface of the user's finger (second input unit).

For example, the first input unit may be a part of the user's body such as the back of the user's hand, and the second input unit may be a body part different from the first input unit, for example, the user's finger. In this case, various shear stress patterns may be identified according to, for example, which location on the body part (first input unit) the user touches using the user's finger (second input unit), how strongly the user presses the body part (first input unit) with the user's finger (second input unit), or in which direction the user's finger (second input unit) moves while pressing the body part (first input unit). How strongly the user presses the body part (first input unit) with the user's finger (second input unit) or in which direction the user's finger moves while pressing the body part (first input unit) may be identified based on the degrees of shape changes and the degrees of color changes on the surface of the user's finger (second input unit) and the surface of the user's body part (first input unit).

In an embodiment of the disclosure, a machine learning technique may be applied to the operation of identifying the shear stress pattern, based on the obtained input. For example, the input obtained through the sensor may include a camera image, the degree of surface deformation, the degree of color deformation, and the like, and a convolution encoder-decoder neural network or the like may be used for an operation of determining the shear stress pattern that is identified by a combination of the position of the contact point, the strength of the shear stress, the direction of the shear stress, and the magnitude of the normal force, based on the obtained input.

In operation 130, the electronic device identifies a control signal corresponding to the sensed input, based on the identified shear stress pattern.

In an embodiment of the disclosure, a specific shear stress pattern may correspond to a specific control signal for controlling the electronic device. According to an embodiment of the disclosure, by matching different control signals to different shear stress patterns, various control signals may be input to the electronic device, as compared to when it is simply determined whether a control signal is applied according to whether there is a contact.

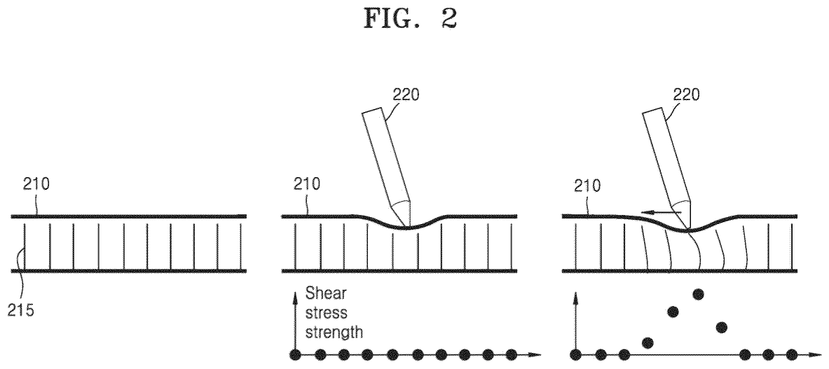

FIG. 2 is a view illustrating a shear stress pattern according to an embodiment of the disclosure.

Referring to FIG. 2, an electronic device according to an embodiment may include a first input unit 210 and a stress sensor 215 embedded under a surface of the first input unit 210. The stress sensor 215 may obtain an input according to an interaction between the first input unit 210 and a second input unit 220.

In an embodiment of the disclosure, the interaction between the first input unit 210 and the second input unit 220 may be a contact between the first input unit 210 and the second input unit 220 within a contact region. The contact between the first input unit 210 and the second input unit 220 may generate a shear stress in the contact region.

In an embodiment of the disclosure, the stress sensor 215 embedded in the surface of the first input unit 210 may measure a degree of deformation of the surface of the first input unit 210 in the contact region or a shear stress applied to a contact point on the surface of the first input unit 210. For example, the stress sensor 215 may include a plurality of stress sensor units, and the plurality of stress sensor units may be disposed apart from each other at regular intervals over the surface of the first input unit 210.

The stress sensor 215 may measure a normal force and a shear stress applied to the surface of the first input unit 210. For example, the plurality of stress sensor units included in the stress sensor 215 may measure the normal force and the shear stress at their arrangement points. The normal force applied to the surface of the first input unit 210 may be related to a force with which the second input unit 220 presses the surface of the first input unit 210. The shear stress applied to the surface of the first input unit 210 may be related to a force with which the second input unit 220 applies to the surface of the first input unit 210 in a direction parallel to the surface of the first input unit 210.

The electronic device may identify a shear stress pattern according to contact between the first input unit 210 and the second input unit 220, based on the normal force and shear stress measured by the stress sensor 215.

In an embodiment of the disclosure, a user may touch or press a portion of the surface of the first input unit 210 by using the second input unit 220. At this time, the normal force and the shear stress may be applied to a contact region of the first input unit 210 and the second input unit 220. The user may cause a shape change or a color change on the surface of the first input unit 210 by bringing the first input unit 210 and the second input unit 220 into contact. The electronic device may identify the shear stress pattern from shape deformation information or color deformation information on the surface of at least one of the first input unit 210 or the second input unit 220 in the contact region where the first input unit 210 and the second input unit 220 contact each other.

The shear stress pattern may be identified based on at least one of the position of the contact point where the first input unit 210 and the second input unit 220 contact each other, the strength of the shear stress, the direction of the shear stress, or the magnitude of the normal force.

Referring to FIG. 2, the first input unit 210 may be a display screen included in the electronic device, and the second input unit 220 may be a stylus pen. In this case, various shear stress patterns may be identified according to, for example, which location on the first input unit 210 the user touches using the second input unit 220, how strongly the user presses the first input unit 210 with the second input unit 220, or in which direction the second input unit 220 moves while pressing the first input unit 210. How strongly the user presses the first input unit 210 by using the second input unit 220 may be identified, for example, based on the normal force measured through the stress sensor 215.

In an embodiment of the disclosure, the first input unit 210 may be a display screen included in the electronic device, and the second input unit 220 may be the user's finger. In this case, how strongly the user presses the first input unit 210 with the second input unit 220 or in which direction the second input unit 220 moves while pressing the first input unit 210 may be identified based on the normal force measured through the stress sensor 215, the degree of shape change on the surface of the second input unit 220, and the degrees of color change on the surface of the second input unit 220.

In an embodiment of the disclosure, the user may apply the shear stress so that the second input unit 220 does not relatively move with respect to the surface of the first input unit 210. In this case, the strength of the shear stress is less than a maximum static friction force. When the second input unit 220 does not move relative to the surface of the first input unit 210, the electronic device may make the shear stress pattern correspond to a control signal in a manner similar to a ‘joystick’.

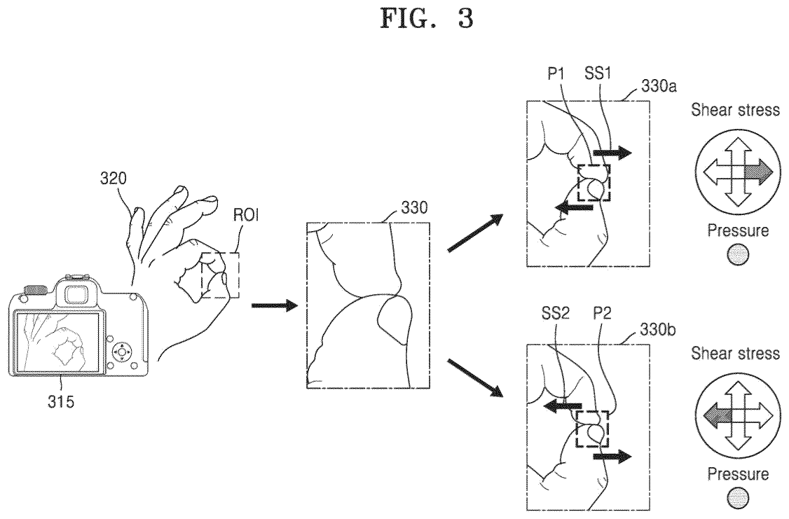

FIG. 3 is a view illustrating an operation of identifying a shear stress pattern by using a camera 315, according to an embodiment of the disclosure.

Referring to FIG. 3, an electronic device may include a camera 315 for obtaining an image, and the electronic device may obtain an input according to an interaction between a first input unit and a second input unit through the camera 315.

In an embodiment of the disclosure, the interaction between the first input unit and the second input unit may be a contact between two fingers of a user within a field of view (FOV) of the camera 315. The contact between the first input unit (first finger) and the second input unit (second finger) may generate a shear stress in a contact region.

In the disclosure, the FOV of the camera 315 indicates an image captured by the camera 315 or a region of the image. The FOV may be expressed as an FOV degree. In order to input a control signal to the electronic device, the user may touch the two fingers to generate a shear stress in a region of interest (ROI) of the contact region.

Referring to FIG. 3, the electronic device may obtain an image or an image of a contact region between the first input unit (first finger) and the second input unit (second finger) through the camera 315. The image or image obtained through the camera 315 may include information related to shape deformation in surfaces of the first input unit and the second input unit and information related to color change in the surfaces of the first and second input units in the contact region ROI. The information related to the shape deformation in the surfaces of the first and second input units and the information related to the color change in the surfaces of the first and second input units may be related to a shear stress applied between the first input unit and the second input unit.

The electronic device may identify a shear stress pattern according to contact between the first input unit (first finger) and the second input unit (second finger), based on an image of the ROI obtained by the camera 315.

In an embodiment of the disclosure, the user may make the first input unit (first finger) and the second input unit (second finger) contact each other, and may apply a force between the first input unit and the second input unit. In this case, a pressure and a shear stress may be applied to the contact region between the first input unit and the second input unit. The user may cause a shape change or color change on the surfaces of the first input unit and the second input unit by bringing the first input unit and the second input unit into contact. The electronic device may identify the shear stress pattern from shape deformation information or color deformation information on the surface of at least one of the first input unit or the second input unit in the contact region where the first input unit and the second input unit contact each other.

The shear stress pattern may be identified based on at least one of a position of the contact point where the first input unit and the second input unit contact each other, the strength of the shear stress, the direction of the shear stress, or the magnitude of a normal force.

Referring to FIG. 3, the first input unit may be the user's first finger, and the second input unit may be a second finger different from the first finger. In this case, how much force the user applies between the first finger and the second finger or in which direction the user applies the force while the first finger and the second finger are in contact with each other may be identified based on the degrees of shape deformation and color deformation of the surfaces of the first and second fingers included in the image obtained through the camera 315. In an embodiment of the disclosure, a machine learning technique may be applied to the operation of identifying the shear stress pattern, based on the obtained image. For example, a convolution encoder-decoder neural network or the like may be used for an operation of determining the shear stress pattern that is identified by a combination of the position of a contact point, the strength of the shear stress, the direction of the shear stress, and the magnitude of a normal force, based on the image obtained through the camera 315.

The electronic device may obtain images 330, 330a, and 330b corresponding to the ROI of the first finger and the second finger through the camera 315. The case of the image 330 may be determined as a case where the first finger and the second finger are only in contact with each other. The case of the image 330a may be determined as a case where a clockwise shear stress pattern SS1 has been applied based on a skin shape change and color change in the first finger and the second finger in a region P1 where the first finger and the second finger are in contact. Likewise, the case of the image 330b may be determined as a case where a counterclockwise shear stress pattern SS2 has been applied based on a skin shape change and color change in the first finger and the second finger in a region P2 where the first finger and the second finger are in contact. In each case, the electronic device may obtain a control signal corresponding to an identified shear stress pattern.

As such, spatial gesture technology or computer vision technology may be applied to the electronic device according to an embodiment of the disclosure.

Computer vision technology refers to realizing human vision through a computer. In other words, computer vision may be related to AI systems that extract information from images. An operation of extracting information from an image may include, for example, a technology of ascertaining three-dimensional (3D) spatial information, such as the type, size, direction, and location of an object in the image, in real time, a technology of identifying objects like humans and recognizing respective motions of the objects, or a technology in which a machine recognizes its own location. In computer vision, cameras, edge-based or cloud-based computing, software, and AI are combined with one another to enable systems to see and identify things.

In an embodiment of the disclosure, the shear stress may be applied even when the first input unit and the second input unit are relatively immobile. A shear stress in such a static mode may not be detected according to a general gesture recognition method of tracking the ‘movement’ of an object. When the user applies a force between two fingers without changing relative positions of the two fingers, the shape or color of a finger skin in the contact region may change. For example, the shape of an elastic skin surface may be changed due to an applied force, and the skin color of a contact body part may be changed due to application of a force to a contact point. Accordingly, the electronic device according to an embodiment of the disclosure may obtain, as an image, the degree of skin deformation of a contact between the first finger and the second finger through the camera 315, and may identify a shear stress pattern, based on the obtained image.

When only the relative positions and relative motions of two input units, for example, two fingers, are identified, only whether the two fingers have contacted each other or the degree of motion differentiation according to a relative interval between the two fingers may be determined. In this case, the number of distinguishable gestures is limited, and the number of control signals inputtable through the gestures is also limited. According to an embodiment of the disclosure, various shear stress patterns between the two input units may be used in addition to the relative positions and relative motions of the two input units, so that various gestures may be distinguished. Accordingly, various control signals may be input to the electronic device through the various gestures.

According to an embodiment of the disclosure, a control signal may be input to the electronic device without additional auxiliary means, by identifying a shear stress pattern in a contact region between the two input units, based on an image obtained through a camera. Even when a separate additional input auxiliary means exists, the accuracy of identification of a control signal input through the auxiliary means may be increased based on analysis of the image obtained through the camera.

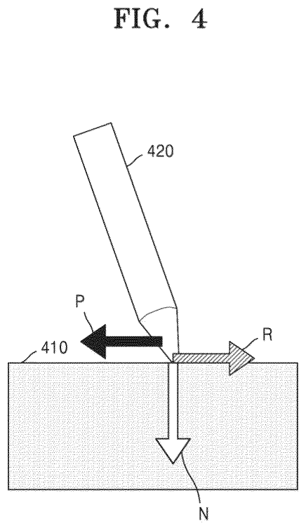

FIG. 4 is a view illustrating a shear stress P according to an embodiment of the disclosure.

The shear stress P is a stress acting parallel to the surface of an object 410, and refers to a resistance force trying to restore the surface of an object to its original state, when a force is applied to the surface of the object from the outside in a direction parallel to the surface of the object.

Referring to FIG. 4, a shear stress pattern may have a static mode or a dynamic mode. In the shear stress pattern of the static mode, the strength of the shear stress P is less than the strength of a maximum static friction force Rₘₐₓ (P≥Rₘₐₓ=kₘₐₓ*N). In an embodiment of the disclosure, a user may apply, to an elastic surface, a shear stress P that is less than the maximum static friction force Rₘₐₓ. In this case, the strength of a force pulled by the user (shear stress P) may be the same as that of a friction force R. In an embodiment of the disclosure, the friction force R may be expressed as a value obtained by multiplying a normal force N by a friction coefficient k. The maximum static friction force Rₘₐₓ may be expressed as a value obtained by multiplying the normal force N by the maximum static friction coefficient kₘₐₓ. For example, when the force (shear stress P) with which a first input unit 410 tries to move in contact with a second input unit 420 is less than the maximum static friction force Rₘₐₓ, a relative motion between the first input unit 410 and the second input unit 420 is not detected. In this case, the strength and direction of the normal force N and the shear stress P may server as elements that constitute the shear stress pattern.

In the shear stress pattern of the dynamic mode, the strength of the shear stress P is greater than the strength of the maximum static friction force Rₘₐₓ (P>Rₘₐₓ=kₘₐₓ*N). For example, when the force (shear stress P) with which the first input unit 410 tries to move in contact with the second input unit 420 is greater than the maximum static friction force Rmax, the relative motion between the first input unit 410 and the second input unit 420 may be detected through a sensor such as a camera. In this case, the relative motion between the first input unit 410 and the second input unit 420 may also be an element that constitutes the shear stress pattern.

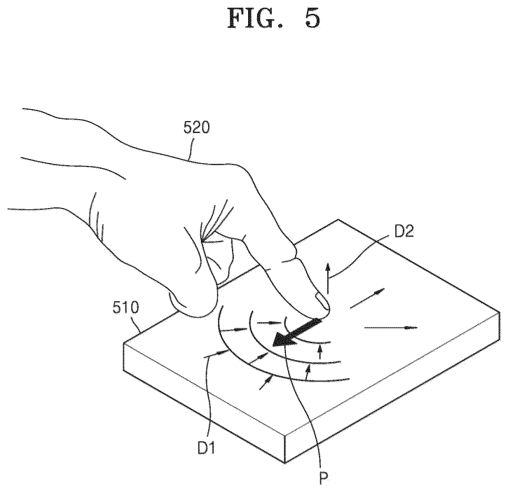

FIG. 5 is a view illustrating a shear stress P and a deformation stress D according to an embodiment of the disclosure.

In one embodiment of the disclosure, a shear stress pattern may be identified based on the strength and direction of the shear stress P. A user may change the pattern of the shear stress P by moving the user's finger (second input unit 520) in contact with a first input unit 510, and may change a control signal that is input to the electronic device. The degree of deformation of an elastic surface of the first input unit 510 is proportional to the strength of the shear stress P applied to the first input unit 510.

In an embodiment of the disclosure, the elastic surface of the first input unit 510 may be deformed due to a resultant force of the normal force N and the shear stress P. When a shape deformation occurs on the surface of the first input unit 510, the deformation stress D is generated. Referring to FIG. 5, a deformation stress D1 trying to avoid a folded surface is generated in a direction toward the shear stress P from a contact point between the first and second input units 510 and 520, and a deformation stress D2 trying to restore a pulled surface is generated in a direction opposite to the shear stress P from the contact point between the first and second input units 510 and 520. In the static mode, the shear stress P, the deformation stress D, and the friction force R may balance one another.

When another object (for example, the second input unit 520) comes into contact with the elastic surface of an object constituting the first input unit 510, the force (i.e., the surface shear stress P and a depth pressure) of an internal system of the first input unit 510 may be deformed. When a horizontal force applied to the elastic surface of the first input unit 510 is less than a maximum static friction force, another object (second input unit 520) in contact with the first input unit 510 stops on the elastic surface relative to the first input unit 510.

The shear stress pattern may be variously determined based on various strengths of applied pressures (which may be related to a normal force) and various strengths of shear stresses. The strength of the pressure and shear stress applied to a contact surface between the first input unit 510 and the second input unit 520 may be obtained through a sensor including a camera or a stress sensor. For example, a shear stress pattern may be obtained by calculating the shear stress from the shape deformation degree and the color deformation degree of the surface of the first input unit 510 or the second input unit 520 identified from an image obtained through the camera, or the shear stress pattern may be obtained from a shear stress measured through the stress sensor.

In an embodiment of the disclosure, the user's hand may be applied to at least one of the first input unit 510 or the second input unit 520. The pressure applied to the skin of the user's hand may change the skin color of a contact part. At a contact part with another object, the skin of the user's hand may change in color due to deformation of blood capillaries. When the user's skin is pressed with another object, the skin color may change as the depth changes. The shear stress P applied to the skin of the user's hand may change the skin shapes of the contact part and its surroundings. The degree of deformation of the skin surface may vary depending on the strength of the applied shear stress P.

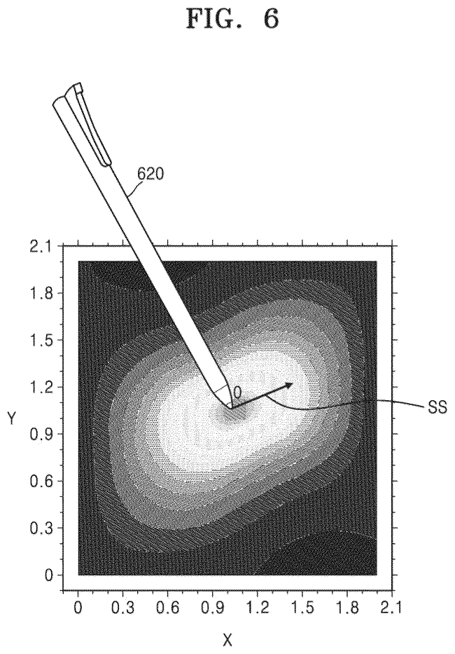

FIG. 6 is a view illustrating an operation of identifying a shear stress pattern SS by using a stress sensor, according to an embodiment of the disclosure.

In an embodiment of the disclosure, the stress sensor may be embedded below the surface of a first input unit. In an embodiment of the disclosure, a surface constituting the first input unit may be elastic and flexible. The stress sensor built into the surface of the first input unit may measure not only the shear stress applied to a contact point 0 where a second input unit 620 contacts the surface of the first input unit, but also the pressure applied by the second input unit 620 to the surface of the first input unit. A normal force generated at the contact point 0 of the first input unit may be identified based on the pressure applied by the second input unit 620 to the surface of the first input unit. In an embodiment of the disclosure, when the first input unit includes a display, a plurality of stress sensor units included in the stress sensor may be arranged apart from each other at regular intervals over the surface of the display. The stress sensor units may measure the applied pressure (normal force) at points where they are arranged.

In an embodiment of the disclosure, the shear stress pattern SS may be identified based on at least one of a position of the contact point 0 where the first input unit and the second input unit 620 contact each other, the strength of the shear stress, the direction of the shear stress, or the magnitude of the normal force. For example, when the normal force has different magnitudes even though the position of the contact point 0 where the first input unit and the second input unit 620 contact each other, the strength of the shear stress, and the direction of the shear stress do not change, it may be considered that different shear stress patterns SS are generated.

Referring to FIG. 6, a normal force according to an interaction between the first input unit and the second input unit 620 may be obtained through the stress sensor built into the surface of the first input unit. Thereafter, the shear stress pattern SS may be identified based on the normal forces of the points obtained through the stress sensor.

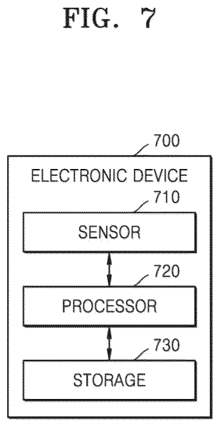

FIG. 7 is a block diagram of an electronic device 700 according to an embodiment of the disclosure.

The electronic device 700 may obtain a control signal by identifying a shear stress pattern in a region where two input units contact each other. For example, the electronic device 700 may perform the method described above with reference to FIG. 1. The electronic device 700 may be, for example, at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, a wearable device, an augmented reality device, a home appliance, and other mobile or non-mobile computing devices.

The AR device, which is capable of expressing an AR, may generally include AR glasses in the form of glasses worn by a user on his or her face, a head mounted display (HMD) worn on his or her head, a virtual reality headset (VRH), an AR helmet, etc. The HMD may provide an extra-large screen to a user by arranging a display in front of the user's eyes, and may provide a realistic virtual world because the screen moves according to the user's movement.

The electronic device 700 is not limited to the above-described examples, and the electronic device 700 may include all kinds of devices capable of identifying a shear stress pattern in a region where the two input units contact each other and obtaining a control signal for controlling the electronic device 700 corresponding to the identified shear stress pattern.

Referring to FIG. 7, the electronic device 700 may include a sensor 710, a processor 720, and a storage 730 (e.g., memory). All of the components illustrated in FIG. 7 are not essential components of the electronic device 700. More or less components than those illustrated in FIG. 7 may constitute the electronic device 700.

The sensor 710 may obtain an input according to an interaction between a first input unit and a second input unit. In an embodiment of the disclosure, the interaction between the first input unit and the second input unit may be a contact between the first input unit and the second input unit within the contact region. For example, a portion of the surface of the first input unit may be in contact with a portion of the surface of the second input unit within the contact region. The contact of the first input unit and the second input unit may generate a shear stress in the contact region, and may be an interaction between the first input unit and the second input unit and thus serve as a basis of an input to the electronic device 700.

In an embodiment of the disclosure, the sensor 710 may include a camera. The camera may obtain an image or a sequence of images. The electronic device 700 may obtain the input according to an interaction between the first input unit and the second input unit, through the sensor 710 including the camera. In an embodiment of the disclosure, the camera may include an image storing unit for obtaining a visual image and a sound storing unit for obtaining an auditory sound. In an embodiment of the disclosure, the camera may be a single structure that is not physically divided into the image storing unit and the sound storing unit. For example, the camera may include at least one of a monocular camera, a binocular camera, an infrared camera, a depth sensor, a lidar, or a UWB radar. The sensor 710 including the camera may correspond to the sensor 315 of FIG. 3 described above.

In an embodiment of the disclosure, the sensor 710 may further include a stress sensor. The electronic device 700 may measure a degree of deformation of the surface of the first or second input unit in the contact region or a shear stress applied to a contact point between the first and second input units, through the stress sensor 710 including the stress sensor. The stress sensor may be embedded in the surface of the first input unit or the second input unit. The stress sensor embedded in the surface of the first input unit may measure a degree of deformation of the surface of the first input unit or a shear stress applied to a contact point on the surface of the first input unit. The stress sensor embedded in the surface of the second input unit may measure a degree of deformation of the surface of the second input unit or a shear stress applied to a contact point on the surface of the second input unit. The sensor 710 including the stress sensor may correspond to the sensor 215 of FIG. 2 described above.

FIG. 8 is a view illustrating a stress sensor according to an embodiment of the disclosure. Referring to FIG. 8, when the electronic device 700 includes a first input unit including a display, a stress sensor may be arranged along an edge of the display (as indicated by 810) or arranged in a grid pattern on a portion of the display (as indicated by 820). In an embodiment of the disclosure, the stress sensor may include a plurality of stress sensor units. The stress sensor units may be spaced apart from one another at regular intervals on the surface of the display (as indicated by 830).

In an embodiment of the disclosure, the stress sensor measuring the degree of deformation of the surface of the first input unit may measure a distance difference between a plurality of feature points on the surface of the first input unit and may obtain the degree of deformation of the surface from the measured distance difference. For example, the stress sensor may obtain the degree of deformation of the surface of the first input unit by comparing pre-stored arrangement information of the plurality of feature points on the surface of the first input unit in a non-contact initial state with arrangement information of the plurality of feature points in a state in which contact has been made.

The display may output a visual image by displaying the visual image to the outside. For example, the display may output an image sequence to the outside. In an embodiment of the disclosure, the display may include a panel. The display may include at least one selected from, for example, a liquid crystal display (LCD), a digital mirror device, a liquid crystal on silicon, a thin film transistor-liquid crystal display (TFT-LCD), an organic light-emitting diode (OLED), a micro LED, a flexible display, a 3D display, or an electrophoretic display.

The storage 730 may store a program that is to be executed by the processor 720, which will be described later, in order to control an operation of the electronic device 700. The storage 730 may store a program including one or more instructions for controlling an operation of the electronic device 700. Instructions and program code readable by the processor 720 may be stored in the storage 730. In an embodiment of the disclosure, the processor 720 may be implemented to execute instructions or codes of the program stored in the storage 730. The storage 730 may store data that is input to the electronic device 700 or output from the electronic device 700.

The storage 730 may include at least one type of storage medium from among a flash memory, a hard disk, a multimedia card micro type storage medium, a card type storage (for example, SD or XD storage), a random access memory (RAM), a static RAM (SRAM), a read-only memory (ROM), an electrically erasable programmable ROM (EEPROM), a programmable ROM (PROM), a magnetic storage, a magnetic disk, and an optical disk.

The programs stored in the storage 730 may be classified into a plurality of modules according to their functions.

The processor 720 may control overall operations of the electronic device 700. The processor 720 may perform operations according to an embodiment of the disclosure. For example, the processor 720 may entirely control the sensor 710 including a camera, the display, and the storage 730 by executing the programs stored in the storage 730.

The processor 720 may include hardware components that perform arithmetic, logic, input/output operations and signal processing. The processor 720 may include, but is not limited to, at least one of a central processing unit, a microprocessor, a graphics processing unit, application specific integrated circuits (ASICs), digital signal processors (DSPs), digital signal processing devices (DSPDs), programmable logic devices (PLDs), or field programmable gate arrays (FPGAs).

The processor 720 executes the one or more instructions stored in the storage 730 to obtain an input according to the interaction between the first input unit and the second input unit through the sensor 710, identify the shear stress pattern in a region where the first input unit and the second input unit contact each other, and identify a control signal corresponding to the input, based on the identified shear stress pattern.

In an embodiment of the disclosure, the first input unit may include an elastic surface having elasticity and flexibility. The elastic surface may include a region where the first input unit and the second input unit contact each other. The second input unit may include at least one of a user's finger or a stylus pen. The second input unit may also include an elastic surface having elasticity and flexibility.

In an embodiment of the disclosure, the processor 720 executes the one or more instructions stored in the storage 730 to identify a shear stress pattern, based on the degree of deformation of the elastic surface in the region where the first input unit and the second input unit contact each other. The degree of deformation of the elastic surface may include at least one of the degree of shape deformation of the elastic surface or the degree of color deformation of the elastic surface.

In an embodiment of the disclosure, the processor 720 executes the one or more instructions stored in the storage 730 to identify a shear stress pattern, based on at least one of a location where the first input unit and the second input unit contact each other, the strength of the shear stress, the direction of the shear stress, or the magnitude of the normal force.

In an embodiment of the disclosure, a specific shear stress pattern may correspond to a specific control signal for controlling the electronic device. According to an embodiment of the disclosure, by matching different control signals to different shear stress patterns, various control signals may be input to the electronic device, as compared to when it is simply determined whether a control signal is applied according to whether there is a contact.

As such, according to an embodiment of the disclosure, various control signals may be input to an electronic device by identifying a control signal corresponding to an input, based on a shear stress pattern in a region where two input units are in contact with each other. By identifying a shear stress pattern in a contact region where two input units contact each other, based on an image of the contact region obtained through a camera, a control signal may be input to an electronic device without additional separate auxiliary means, or the accuracy of identification of a control signal input through an auxiliary means may be more increased.

Various embodiments of the disclosure may be implemented or supported by one or more computer programs, and the one or more computer programs may be formed from computer-readable program code and may be included in computer-readable media. According to the disclosure, an “application” and a “program” may represent one or more computer programs, software components, instruction sets, procedures, functions, objects, classes, instances, related data, or a portion thereof, which are suitable for implementation in computer-readable program code. “Computer-readable program code” may include various types of computer code including source code, objective code, and executable code. “Computer-readable media” may include various types of media that may be accessed by a computer, like read only memory (ROM), random access memory (RAM), a hard disk drive (HDD), a compact disk (CD), a digital video disk (DVD), and various other types of memory.

Machine-readable storage media may be provided as non-transitory storage media. The non-transitory storage media are tangible devices and may exclude wired, wireless, optical, or other communication links that transmit temporary electrical or other signals. The non-transitory storage media do not distinguish between a case in which data is semi-permanently stored in storage media and a case in which data is temporarily stored in storage media. For example, the non-transitory storage media may include a buffer in which data is temporarily stored. Computer readable media can be any available media which can be accessed by computers, and may include all volatile/non-volatile and removable/non-removable media. Computer readable media includes media in which data can be permanently stored and media in which data can be stored and later overwritten, such as rewritable optical disks or removable memory devices.

According to an embodiment of the disclosure, a method according to various disclosed embodiments may be provided by being included in a computer program product. The computer program product, which is a commodity, may be traded between sellers and buyers. Computer program products may be distributed in the form of device-readable storage media (e.g., compact disc read only memory (CD-ROM)), or may be distributed (e.g., downloaded or uploaded) through an application store (e.g., Play Store) or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While the disclosure has been particularly shown and described with reference to exemplary embodiments thereof, it will be understood that various changes in form and details may be made therein without departing from the spirit and scope of the disclosure. Thus, the above-described embodiments should be considered in descriptive sense only and not for purposes of limitation. For example, each component described as a single type may be implemented in a distributed manner, and similarly, components described as being distributed may be implemented in a combined form.

The scope of the disclosure is indicated by the scope of the claims to be described later rather than the above detailed description, and all changes or modified forms derived from the meaning and scope of the claims and the concept of equivalents thereof should be interpreted as being included in the scope of the disclosure.

1. A method of obtaining a control signal by identifying a shear stress pattern in a region where two inputters contact each other, the method comprising:
obtaining, through a camera, an input image of a region in which a first inputter and a second inputter contact each other, wherein the first inputter is a first body part and the second inputter is a second body part;
identifying the shear stress pattern in the region in which the first inputter and the second inputter contact each other; and
identifying, based on the identified shear stress pattern, a corresponding control signal.

2-5. (canceled)

6. The method of claim 1, wherein the shear stress pattern is identified based on a degree of deformation in the region in which the first inputter and the second inputter contact each other.

7. The method of claim 6, wherein the degree of deformation comprises at least one of a degree of shape deformation or a degree of color deformation of the elastic surface.

8. The method of claim 1, wherein the shear stress pattern is identified based on at least one of a location where the first inputter and the second inputter contact each other, a strength of a shear stress, a direction of the shear stress, or a magnitude of a normal force.

9-10. (canceled)

11. An electronic device for obtaining a control signal by identifying a shear stress pattern in a region where two inputters contact each other, the electronic device comprising:
a camera configured to obtain an input image;
a memory configured to store a program including at least one instruction; and
at least one processor configured to execute the at least one instruction stored in the memory to:
obtain, through the camera, the input image of a region in which first inputter and a second inputter contact each other, wherein the first inputter is a first body part and the second inputter is a second body part;
identify the shear stress pattern in the region in which the first inputter and the second inputter contact each other; and
identify, based on the identified shear stress pattern, a corresponding.

12-13. (canceled)

14. The electronic device of claim 1311, wherein the at least one processor is further configured to execute the at least one instruction to identify the shear stress pattern, based on a degree of deformation in the region in which the first inputter and the second inputter contact each other.

15. A non-transitory computer-readable recording medium having recorded thereon a computer program, which, when executed by a computer, performs a method comprising:
obtaining, through a camera, an input image of a region in which a first inputter and a second inputter contact each other, wherein the first inputter is a first body part and the second inputter is a second body part;
identifying a shear stress pattern in the region in which the first inputter and the second inputter contact each other; and
identifying, based on the identified shear stress pattern, a corresponding control.
